(19) United States
(12) Patent Application Publication
(10) Pub. No.: US 2015/0022876 A1
(43) Pub. Date: Jan. 22, 2015

(54) MULTI-STATE INTERFEROMETRIC MODULATOR WITH COLOR ATTENUATOR

(71) Applicant: QUALCOMM MEMS Technologies, Inc., San Diego, CA (US)

(72) Inventors: Jian J. Ma, Carlsbad, CA (US); Chong U. Lee, San Diego, CA (US); Tallis Young Chang, San Diego, CA (US); John H. Hong, San Clemente, CA (US)

(21) Appl. No.: 13/947,837

(22) Filed: Jul. 22, 2013

(51) Int. Cl. G02B 26/08

(52) U.S. Cl. CPC G02B 26/0833
USPC 359/291

(57) ABSTRACT

This disclosure provides systems, methods and apparatus for multi-state interferometric modulator (MS-IMOD) implementations with an improved white-state color by incorporating an attenuator. The attenuator may be part of a mirror stack or part of an absorber stack. The attenuator may be capable of reducing the amount of green light reflected when the MS-IMOD is in a white state. The attenuator may include an absorber and/or a notch filter. In some implementations, the white color that is reflected when the MS-IMOD is in the white state may be substantially similar to that of CIE Standard Illuminant D65.

### TECHNICAL FIELD

This disclosure relates to electromechanical systems and devices, and more particularly to electromechanical systems for implementing reflective display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Some IMODs are bi-stable IMODs, meaning that they can be configured in only two positions, open or closed. A single image pixel may include three or more bi-stable IMODs, each of which corresponds to a subpixel. In a display device that includes multi-state interferometric modulators (MS-IMODs) or analog IMODs (A-IMODs), a pixel's reflective color may be determined by the gap spacing or “gap height” between an absorber stack and a reflector stack of a single IMOD. Some A-IMODs may be positioned in a substantially continuous manner between a large number of gap heights, whereas MS-IMODs may generally be positioned in a smaller number of gap heights. As a result, an A-IMOD may be considered as a special case of the class of MS-IMODs—that is, as an MS-IMOD with a very large number of controllable gap heights. Accordingly, A-IMODs and MS-IMODs may both referred to herein as MS-IMODs, or simply as IMODs.

### SUMMARY

The systems, methods and devices of this disclosure each have several innovative aspects, no single one of which is solely responsible for the desirable attributes disclosed herein.

One innovative aspect of the subject matter described in this disclosure can be implemented in an IMOD that includes a mirror stack, a substantially transparent substrate and an absorber stack disposed on the substantially transparent substrate. The absorber stack may include at least one absorber layer and the mirror stack may include a reflective layer, such as a metal reflective layer. The absorber stack and the mirror stack may be capable of being positioned in a plurality of positions relative to one another to form a plurality of gap heights. Each reflective color of a plurality of reflective colors of the IMOD may correspond with a gap height of the plurality of gap heights. The mirror stack and/or the absorber stack may include an attenuator capable of attenuating energy of light corresponding to one or more wavelength ranges. For example, the attenuator may be capable of attenuating a wavelength range corresponding with green colors. In some implementations, the absorber stack may include the attenuator. For example, the absorber stack may include a first absorber layer proximate the substantially transparent substrate, a second absorber layer and a substantially transparent stack disposed between the first absorber layer and the second absorber layer.

In some implementations, the absorber stack may include an impedance-matching layer. The impedance-matching layer may be disposed between the first absorber layer and the substantially transparent substrate or disposed proximate the second absorber layer.

Alternatively, or additionally, the mirror stack may include an attenuator. For example, the attenuator may include a notch filter. The notch filter may include a partially reflective partially absorptive layer and a substantially transparent layer disposed between the partially reflective layer and the reflective layer. The mirror stack may include a mirror stack low-index layer, having a relatively lower index of refraction, proximate the notch filter. The mirror stack may include a mirror stack high-index layer, having a relatively higher index of refraction, proximate the mirror stack low-index layer.

In some implementations, a display device may include the IMOD. For example, the IMOD may be part of an array of IMODs included in the display device. The display device may include a control system capable of controlling the display device. The control system may be capable of processing image data. The control system also may include a driver circuit capable of sending at least one signal to a display of the display device and a controller capable of sending at least a portion of the image data to the driver circuit.

In some implementations, the control system also may include an image source module capable of sending the image data to the processor. The image source module may include a receiver, a transceiver, and/or a transmitter. The display device may include an input device capable of receiving input data and of communicating the input data to the control system.

Another innovative aspect of the subject matter described in this disclosure can be implemented in an IMOD that includes a mirror stack having a reflective layer and a notch filter. The IMOD may include a substantially transparent substrate and an absorber stack disposed on the substantially transparent substrate. The absorber stack may include at least one absorber layer. The absorber stack and the mirror stack may be capable of being positioned in a plurality of positions relative to one another, to form a plurality of gap heights. Each reflective color of a plurality of reflective colors of the IMOD may correspond with a gap height of the plurality of gap heights.

In some implementations, the notch filter may include a partially reflective layer and a substantially transparent layer disposed between the partially reflective layer and the reflective layer. The notch filter may be capable of attenuating a wavelength range corresponding with green colors.

In some implementations, the mirror stack may include a mirror stack low-index layer, having a relatively lower index of refraction, proximate the notch filter. The mirror stack may include a mirror stack high-index layer, having a relatively higher index of refraction, proximate the mirror stack low-index layer.

Another innovative aspect of the subject matter described in this disclosure can be implemented in an IMOD that includes a mirror stack, a substantially transparent substrate and an absorber stack disposed on the substantially transparent substrate. The mirror stack may include a reflective layer. The absorber stack may be capable of attenuating energy of light corresponding to one or more wavelength ranges.

The absorber stack may include a first absorber layer proximate the substantially transparent substrate, a second absorber layer and a substantially transparent stack disposed between the first absorber layer and the second absorber layer. The absorber stack and the mirror stack may be capable of being positioned in a plurality of positions relative to one another to form a plurality of gap heights. Each reflective color of a plurality of reflective colors of the IMOD may correspond with a gap height of the plurality of gap heights.

In some implementations, the absorber stack may include an impedance-matching layer. For example, the impedance-matching layer may be disposed between the first absorber layer and the substantially transparent substrate or disposed proximate the second absorber layer.

Details of one or more implementations of the subject matter described in this specification are set forth in the accompanying drawings and the description below. Although the examples provided in this summary are primarily described in terms of electromechanical systems (EMS) based displays, the concepts provided herein may apply to other types of displays, such as liquid crystal displays (LCDs), organic light-emitting diode (OLED) displays, electrophoretic displays, and field emission displays, as well as to other non-display EMS devices, such as EMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an isometric view illustration depicting two adjacent example interferometric modulator (IMOD) display elements in a series or array of display elements of an IMOD display device.

FIG. 2 shows a system block diagram illustrating an example electronic device incorporating an IMOD-based display including a three element by three element array of IMOD display elements.

FIG. 3 shows a flow diagram illustrating an example manufacturing process for an IMOD display or display element.

FIGS. 4A-4E show cross-sectional illustrations of various stages in an example process of making an IMOD display or display element.

FIGS. 5A-5E show examples of how a multi-state IMOD (MS-IMOD) may be positioned to produce different colors.

FIG. 6 shows an example of an optical stack for an MS-IMOD that provides an improved white-state color.

FIG. 7 shows a block diagram of an example apparatus that includes a control system and an array of pixels.

FIG. 8 shows examples of the mirror stack reflectivity of the MS-IMOD of FIG. 6 across the visible spectrum with partially reflective layers of different thicknesses and without a partially reflective layer.

FIG. 9 shows example standing waves for red, green and blue superimposed on the stack shown in FIG. 6, when the MS-IMOD is positioned in a white state.

FIG. 10 shows an example of a color spiral generated by varying the air gap between the mirror stack and the absorber stack of the MS-IMOD shown in FIG. 6 from substantially zero nm to approximately 600 nm.

FIG. 11 shows an example of an MS-IMOD that includes an attenuator in the absorber stack.

FIG. 12 shows an example graph that indicates the reflectivity of the MS-IMOD of FIG. 10 across the visible spectrum with and without the first absorber in the absorber stack.

FIG. 13 shows example standing waves for red, green and blue superimposed on the stack shown in FIG. 11, when the MS-IMOD is positioned in a white state.

FIG. 14 shows an example of a color spiral generated by varying the air gap between the mirror stack and the absorber stack of the MS-IMOD shown in FIG. 11 from substantially zero nm to approximately 600 nm.

FIGS. 15A and 15B show system block diagrams illustrating an example display device that may include a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The white state of a multi-state IMOD (MS-IMOD) occurs when the absorber layer is located at the minimum field intensity of the light. However, because the minimum field intensity (the standing wave) of different wavelengths does not spatially overlap, the color of the white state produced by the MS-IMOD may be shifted depending on the location of the absorber layer. For example, when the location of the absorber layer corresponds with the null of green wavelength field, the reflected green color is reinforced and the white-state color may be tinted with green. Some MS-IMOD implementations provide an improved white-state color by incorporating a color attenuator. The attenuator may be part of a mirror stack or part of an absorber stack. The attenuator may include an absorber and/or a notch filter. The attenuator may be capable of reducing the amount of green light reflected when the MS-IMOD is in a white state.

Particular implementations of the subject matter described in this disclosure can be implemented to realize one or more of the following potential advantages. Some such MS-IMOD implementations may provide an improved white state and good color saturation. For example, the white color that is reflected when the MS-IMOD is in the white state may be substantially similar to that of CIE Standard Illuminant D65. Moreover, a properly designed attenuator may offer additional design flexibility in the overall pixel design, such as the incorporation of an air gap for the white state which can be an important design element for reliability considerations.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

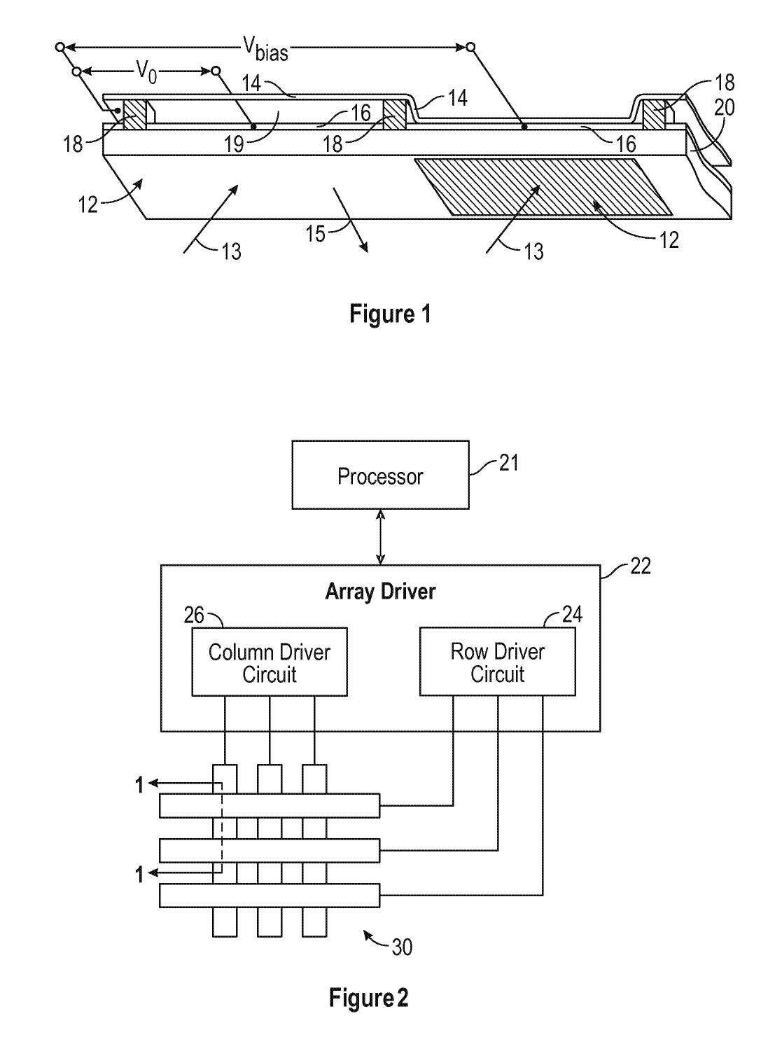

FIG. 1 is an isometric view illustration depicting two adjacent example interferometric modulator (IMOD) display elements in a series or array of display elements of an IMOD display device. The IMOD display device includes one or more interferometric EMS, such as MEMS, display elements. In these devices, the interferometric MEMS display elements can be positioned in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be capable of reflecting predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage Vₒ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be adapted to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows a system block diagram illustrating an example electronic device incorporating an IMOD-based display including a three element by three element array of IMOD display elements. The electronic device includes a processor 21 that may be capable of executing one or more software modules. In addition to executing an operating system, the processor 21 may be capable of executing one or more software applications, including a web browser, a telephone application, an email program, or any other software application.

The processor 21 can be capable of communicating with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

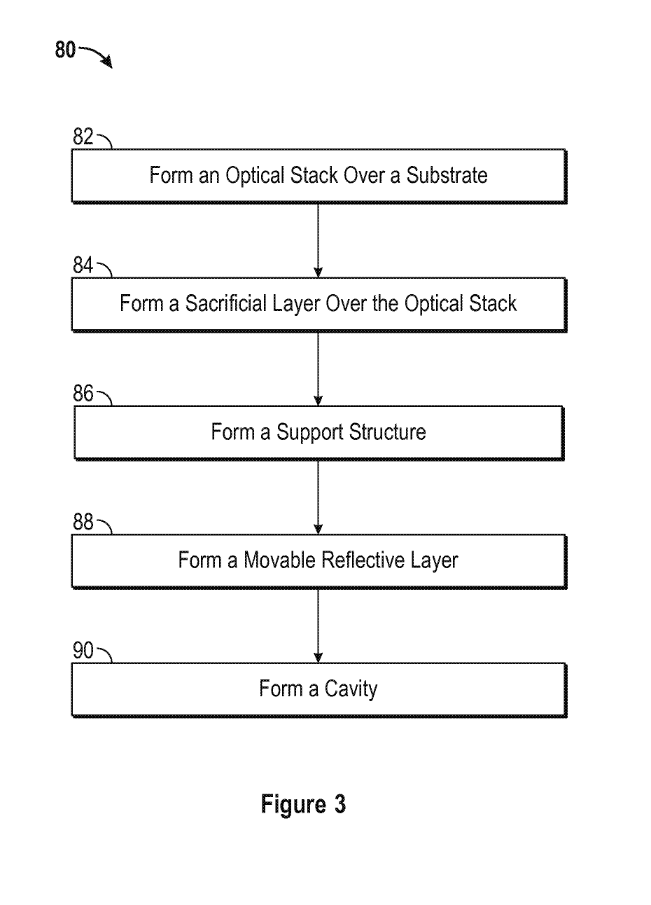

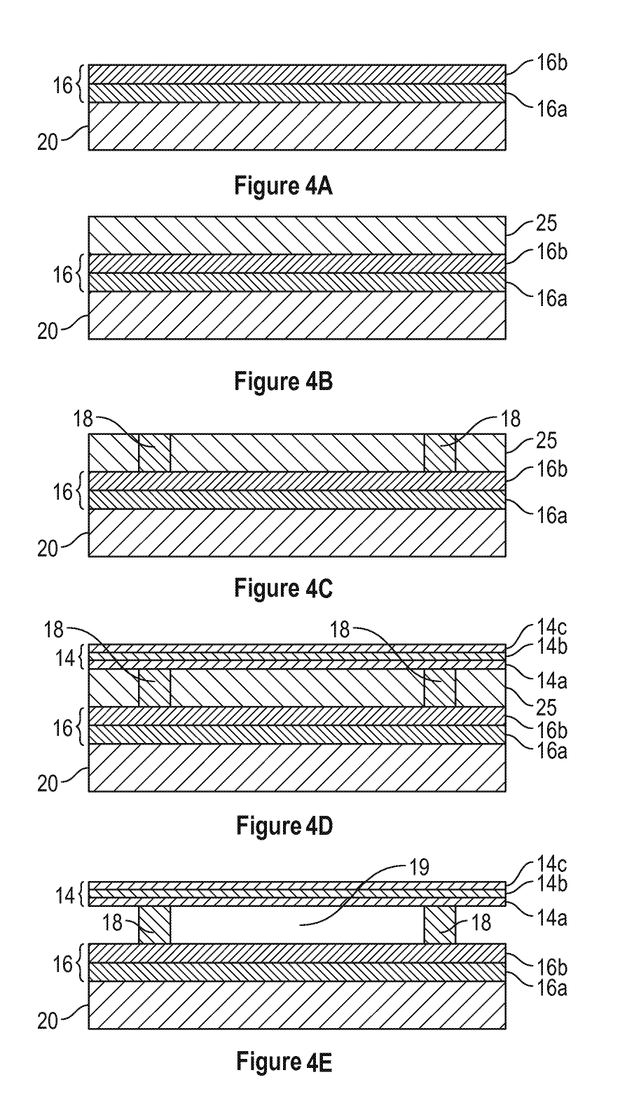

FIG. 3 shows a flow diagram illustrating an example manufacturing process for an IMOD display or display element. FIGS. 4A-4E show cross-sectional illustrations of various stages in an example manufacturing process for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can include both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 44. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be capable of protecting the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

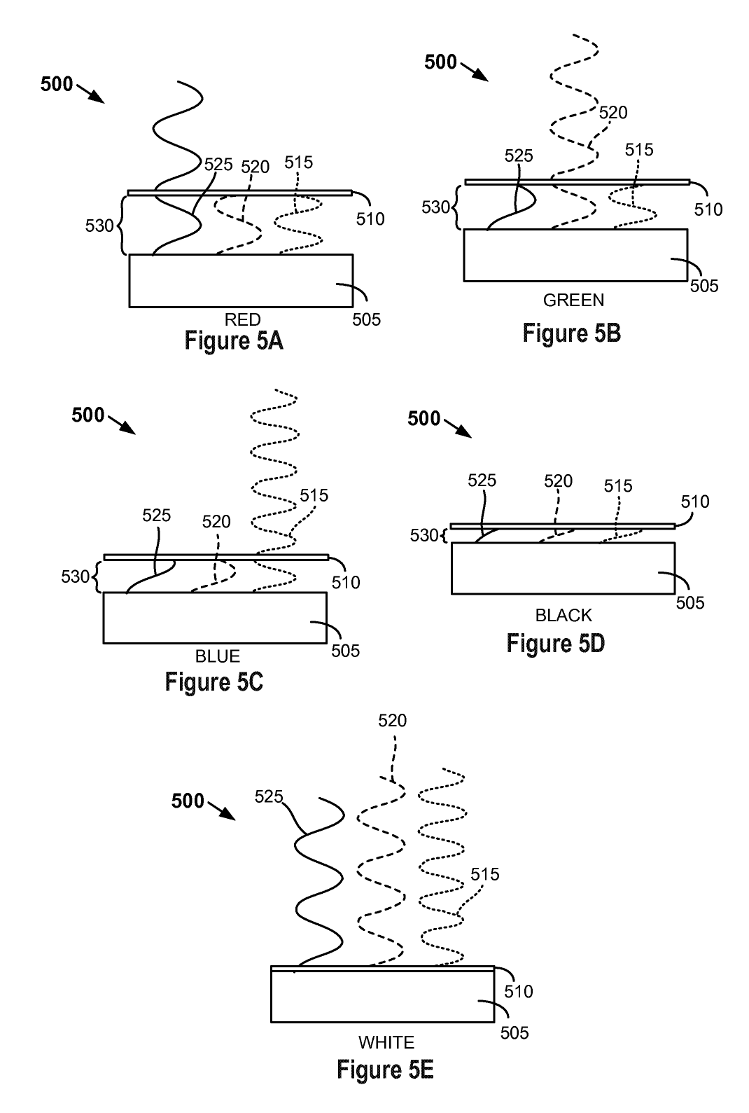

FIGS. 5A-5E show examples of how a multi-state IMOD (MS-IMOD) may be positioned to produce different colors. As noted above, analog IMODs (A-IMODs) and multi-state IMODs (MS-IMODs) are considered to be examples of the broader class of MS-IMODs.

In an MS-IMOD, a pixel's reflective color may be varied by changing the gap height between an absorber stack and a reflector stack. In FIGS. 5A-5E, the MS-IMOD 500 includes the mirror stack 505 and the absorber stack 510. In this implementation, the absorber stack 510 is partially reflective and partially absorptive. Here, the mirror stack 505 includes at least one metallic reflective layer, which also may be referred to herein as a mirrored surface or a metal mirror.

In some implementations, an absorber layer of the absorber stack 510 may be formed of a partially absorptive and partially reflective layer. The absorber layer may be part of an absorber stack that includes other layers, such as one or more dielectric layers, an electrode layer, etc. According to some such implementations, the absorber stack 510 may include a dielectric layer, a metal layer and a passivation layer. In some implementations, the dielectric layer may be formed of silicon dioxide (SiO₂), silicon oxynitride (SiON), magnesium fluoride (MgF₂), aluminum oxide (Al₂O₃) and/or other dielectric materials. In some implementations, the metal layer may be formed of chromium (Cr) and/or molychrome (MoCr, a molybdenum-chromium alloy). In some implementations, the passivation layer may include Al₂O₃ or another dielectric material.

The mirrored surface may, for example, be formed of a reflective metal such as aluminum (Al), silver (Ag), etc. The mirrored surface may be part of a reflector stack that includes other layers, such as one or more dielectric layers. Such dielectric layers may be formed of titanium oxide (TiO₂), silicon nitride (Si₃N₄), zirconium oxide (ZrO₂), tantalum pentoxide (Ta₂O₅), antimony trioxide (Sb₂O₃), hafnium(IV) oxide (HfO₂), scandium(III) oxide (Sc₂O₃), indium(III) oxide (In₂O₃), tin-doped indium(III) oxide (Sn:In₂O₃), SiO₂, SiON, MgF₂, Al₂O₃, hafnium fluoride (HfF₄), ytterbium(III) fluoride (YbF₃), cryolite (Na₃AlF₆) and/or other dielectric materials.

In FIGS. 5A-5E, the mirror stack 505 is shown at five positions relative to the absorber stack 510. However, an MS-IMOD 500 may be movable between substantially more than 5 positions relative to the mirror stack 505. For example, some MS-IMODs may be positioned in 8 or more gap heights 530, 10 or more gap heights 530, 16 or more gap heights 530, 20 or more gap heights 530, 32 or more gap heights 530, etc. Some MS-IMODs also may be positioned with gap heights 530 that correspond to other colors, such as yellow, orange, violet, cyan and/or magenta. In some A-IMOD implementations, the gap height 530 between the mirror stack 505 and the absorber stack 510 may be varied in a substantially continuous manner. In some such MS-IMODs 500, the gap height 530 may be controlled with a high level of precision, e.g., with an error of 10 nm or less.

Although the absorber stack 510 includes a single absorber layer in this example, alternative implementations of the absorber stack 510 may include multiple absorber layers. Moreover, in alternative implementations, the absorber stack 510 may not be partially reflective.

An incident wave having a wavelength λ will interfere with its own reflection from the mirror stack 505 to create a standing wave with local peaks and nulls. The first null is λ/2 from the mirror and subsequent nulls are located at λ/2 intervals. For that wavelength, a thin absorber layer placed at one of the null positions will absorb very little energy.

Referring first to FIG. 5A, when the gap height 530 is substantially equal to the half wavelength of a red wavelength of light 525 (also referred to herein as a red color), the absorber stack 510 is positioned at the null of the red standing wave interference pattern. The absorption of the red wavelength of light 525 is near zero because there is almost no red light at the absorber. At this configuration, constructive interference appears between red wavelengths of light reflected from the absorber stack 510 and red wavelengths of light reflected from the mirror stack 505. Therefore, light having a wavelength substantially corresponding to the red wavelength of light 525 is reflected efficiently. Light of other colors, including the blue wavelength of light 515 and the green wavelength of light 520, has a high intensity field at the absorber and is not reinforced by constructive interference. Instead, such light is substantially absorbed by the absorber stack 510.

FIG. 5B depicts the MS-IMOD 500 in a configuration wherein the mirror stack 505 is moved closer to the absorber stack 510 (or vice versa). In this example, the gap height 530 is substantially equal to the half wavelength of the green wavelength of light 520. The absorber stack 510 is positioned at the null of the green standing wave interference pattern. The absorption of the green wavelength of light 520 is near zero because there is almost no green light at the absorber. At this configuration, constructive interference appears between green light reflected from the absorber stack 510 and green light reflected from the mirror stack 505. Light having a wavelength substantially corresponding to the green wavelength of light 520 is reflected efficiently. Light of other colors, including the red wavelength of light 525 and the blue wavelength of light 515, is substantially absorbed by the absorber stack 510.

In FIG. 5C, the mirror stack 505 is moved closer to the absorber stack 510 (or vice versa), so that the gap height 530 is substantially equal to the half wavelength of the blue wavelength of light 515. Light having a wavelength substantially corresponding to the blue wavelength of light 515 is reflected efficiently. Light of other colors, including the red wavelength of light 525 and the green wavelength of light 520, is substantially absorbed by the absorber stack 510.

In FIG. 5D, however, the MS-IMOD 500 is in a configuration wherein the gap height 530 is substantially equal to ¼ of the wavelength of the average color in the visible range. In such arrangement, the absorber is located near the intensity peak of the interference standing wave; the strong absorption due to high field intensity together with destructive interference between the absorber stack 510 and the mirror stack 505 causes relatively little visible light to be reflected from the MS-IMOD 500. This configuration may be referred to herein as a “black state.” In some such implementations, the gap height 530 may be made larger or smaller than shown in FIG. 5D, in order to reinforce other wavelengths that are outside the visible range. Accordingly, the configuration of the MS-IMOD 500 shown in FIG. 5D provides merely one example of a black state configuration of the MS-IMOD 500.

FIG. 5E depicts the MS-IMOD 500 in a configuration wherein the absorber stack 510 is in close proximity to the mirror stack 505. In this example, the gap height 530 is negligible because the absorber stack 510 is substantially adjacent to the mirror stack 505. Light having a broad range of wavelengths is reflected efficiently from the mirror stack 505 without being absorbed to a significant degree by the absorber stack 510. This configuration may be referred to herein as a “white state.” However, in some implementations the absorber stack 510 and the mirror stack 505 may be separated to reduce stiction caused by charging via the strong electric field that may be produced when the two layers are brought close to one another. In some implementations, one or more dielectric layers with a total thickness of about λ/2 may be disposed on the surface of the absorber layer and/or the mirrored surface. As such, the white state may correspond to a configuration wherein the absorber layer is placed at the first null of the standing wave from the mirrored surface of the mirror stack 505.

In some MS-IMODs, the minimum field intensity (the standing wave) of different wavelengths does not spatially overlap. Therefore, the color of the white state produced by such MS-IMODs may be shifted depending on the location of an absorber layer of the absorber stack. For example, when the location of the absorber layer corresponds with the null of green wavelength field, the reflected green color is reinforced. Therefore, in such instances the white-state color is tinted with green.

Accordingly, some MS-IMOD implementations provide an improved white-state color by incorporating a mirror stack or an absorber stack that includes an attenuator. The attenuator may be capable of reducing the amount of green light reflected when the MS-IMOD is in a white state.

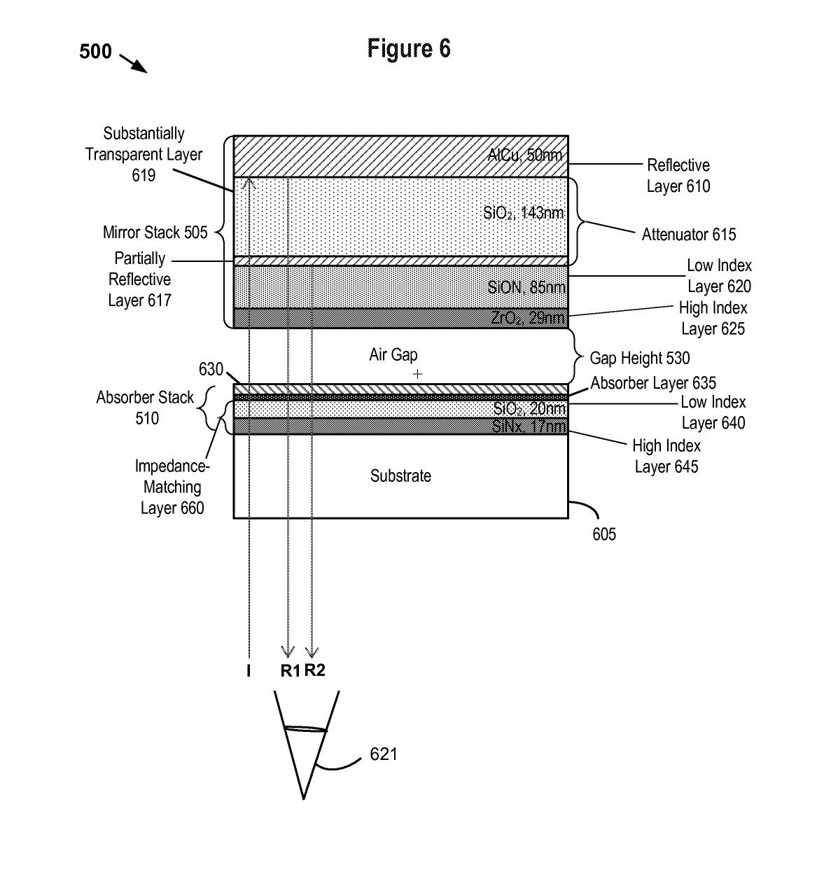

FIG. 6 shows an example of an optical stack for an MS-IMOD that provides an improved white-state color. The layer thicknesses and materials indicated in FIG. 6 are merely provided by way of example.

In this example, the MS-IMOD 500 includes a mirror stack 505 and an absorber stack 510. The absorber stack 510 is formed on a substantially transparent substrate 605, which is a glass substrate in this example. However, in alternative implementations, the substantially transparent substrate 605 may be formed of another suitable material, such as described elsewhere herein.

In some implementations, the absorber stack 510 and the mirror stack 505 may be positioned in a number of positions relative to one another. For example, the MS-IMOD 500 may be included in a display device as part of a display array of substantially similar IMODs. The display device may include a control system capable of controlling the absorber stacks 510 and the mirror stacks 505 of MS-IMODs 500 in the display array to be positioned in a plurality of positions relative to one another. In this implementation, the mirror stack 505 is capable of being moved relative to the absorber stack 510. The gap height 530 between the mirror stack 505 and the absorber stack 510 defines the color(s) reflected from the MS-IMOD 500.

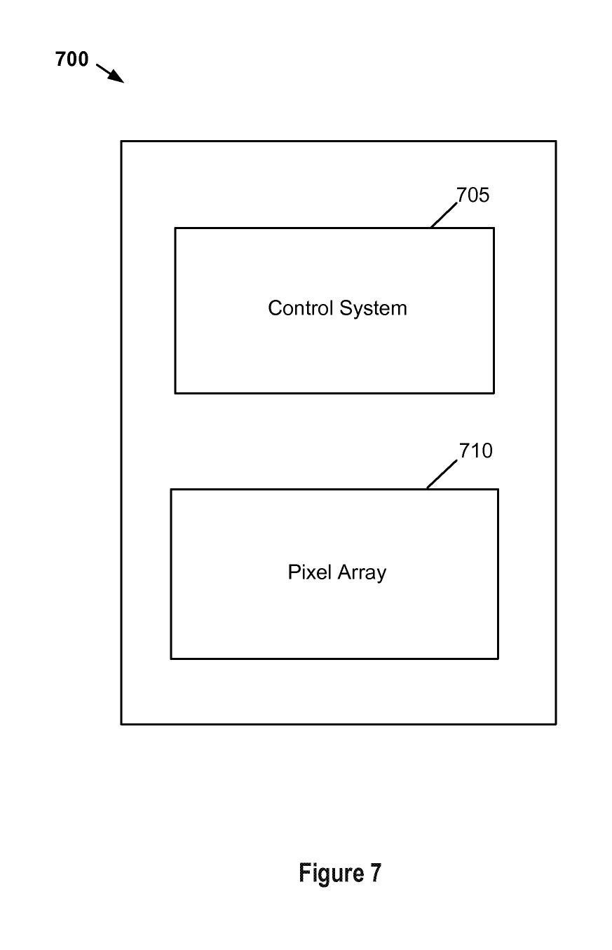

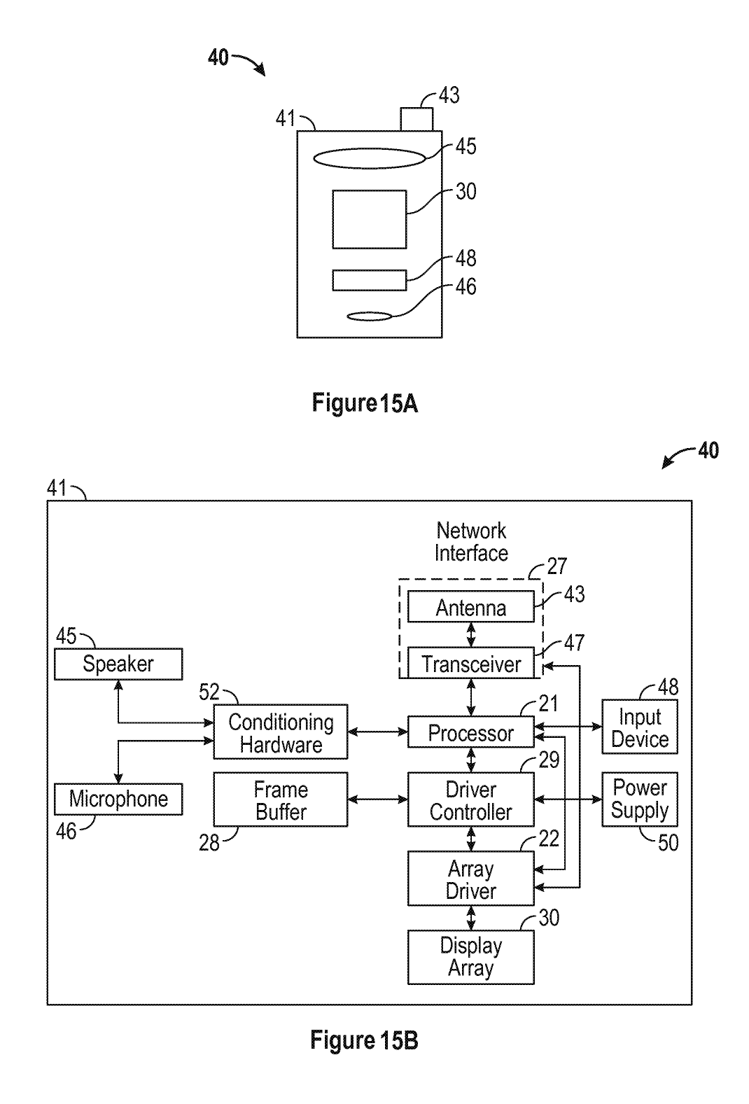

FIG. 7 shows a block diagram of an example apparatus that includes a control system and an array of pixels. The apparatus 700 may, for example, be a display device such as the display device 40 that is described below with reference to FIGS. 15A and 15B. In this example, the apparatus 700 includes a control system 705 and a pixel array 710. The pixel array 710 includes a plurality of pixels, each of which may be capable of producing a plurality of primary colors, white and black. The pixels may, for example, be MS-IMODs. For example, the MS-IMODs 500 described herein may be included in a display array of a display device.

The control system 705 may include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components. The control system 705 may be capable of controlling the absorber stacks 510 and the mirror stacks 505 of IMODs 500 in the display array to be positioned in a plurality of positions relative to one another.

Returning to FIG. 6, in this example the mirror stack 505 includes a reflective layer 610 and an attenuator 615. The attenuator 615 may be capable of attenuating the energy of light corresponding to one or more wavelength ranges. In this example, the attenuator 615 is capable of attenuating a wavelength range corresponding with green colors. Accordingly, the attenuator 615 is capable of reducing the amount of green light reflected when the MS-IMOD 500 is in a white state.

In this implementation, the attenuator 615 is proximate the reflective layer 610 and is capable of functioning as a notch filter. In this example, the attenuator 615 includes a partially reflective layer 617 and a substantially transparent layer 619 disposed between the partially reflective layer 617 and the reflective layer 610 of the mirror stack 505. Light reflected from the partially reflective layer 617 (R2) may cause interference with light reflected from the reflective layer 610 (R1). The position of the observer 621 indicates from which side the MS-IMOD 500 is intended to be viewed.

The thicknesses of the partially reflective layer 617 and the substantially transparent layer 619 of the attenuator 615 may be tuned to produce a “notch” or reduction in reflectance in a desired wavelength range. In this implementation, the attenuator 615 is configured such that the interference attenuates wavelengths in the 500 nm to 600 nm range, producing an attenuated wavelength range corresponding to green colors. However, the peak wavelength and/or the attenuated wavelength range (the notch width) may be different in different implementations. The absorption peak frequency may be controlled according to the thickness of the substantially transparent layer 619. The amount of attenuation is controlled by the reflectivity of the partially reflective layer 617, which can be tuned according to the thickness of the partially reflective layer 617. Accordingly, a higher reflectivity of the partially reflective layer leads to a smaller attenuation. The attenuated wavelength range also may be determined by the thickness of the partially reflective layer 617. However, because the reflectivity depends upon thickness, it can be difficult to control the wavelength range without affecting the amount of attenuation.

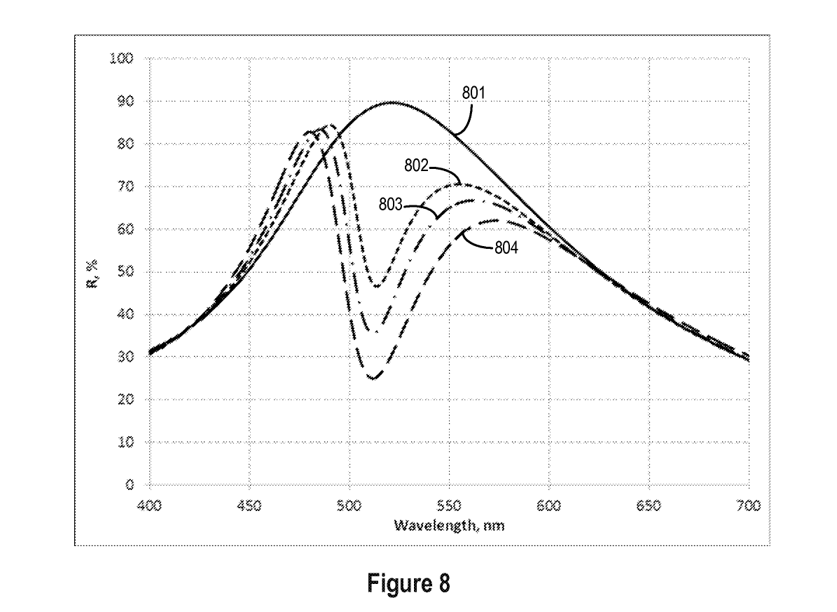

FIG. 8 shows examples of the mirror stack reflectivity of the MS-IMOD of FIG. 6 across the visible spectrum with partially reflective layers of different thicknesses and without a partially reflective layer. In this example, curve 801 indicates the reflectivity of an MS-IMOD that does not include the attenuator 615. Curves 802, 803 and 804 indicate the reflectivity of an MS-IMOD that includes attenuators 615, wherein the partially reflective layer 617 has thicknesses of 19 nm, 16 nm and 13 nm, respectively. In this example, in order to align the attenuation peak at the same wavelength, the thickness of the substantially transparent layer 619 is adjusted to be 141.5 nm, 143 nm and 144.5 nm, respectively.

Here, the partially reflective layer 617 of the attenuator is formed of an alloy of aluminum and copper and is approximately 16 nm in thickness. However, in some other implementations the partially reflective layer 617 may include other reflective materials, such as silver or another reflective metal, and may be thicker or thinner. In this implementation, the substantially transparent layer 619 of the attenuator 615 includes a layer of SiO₂. However, in alternative implementations, the substantially transparent layer 619 may include one or more other materials, such as substantially transparent dielectric material, and may have a different thickness. In some such alternative examples, the substantially transparent layer 619 may include silicon oxynitride (SiOₓN_{y}), SiₓN_{y} or another such material.

In alternative implementations, the attenuator 615 may include an absorber layer. Some examples are provided below of attenuators 615 that include an additional absorber layer in the absorber stack 510. However, in some alternative implementations, the attenuator 615 includes an absorber layer in the mirror stack 505. Because such an absorber layer is part of the mirror stack 505, not the absorber stack 510, this absorber layer of the attenuator 615 may be referred to herein as a “mirror stack absorber layer.” In some such implementations, the partially reflective layer 617 may be partially reflective and partially absorptive.

Here, the mirror stack 505 also includes a mirror stack low-index layer 620, having a relatively lower index of refraction, proximate the attenuator 615. In this example, the mirror stack low-index layer 620 is formed of SiON. However, in some other implementations, the mirror stack low-index layer 620 may include other low-index materials, such as SiO₂, and may be thicker or thinner. The mirror stack 505 also includes a mirror stack high-index layer 625, having a relatively higher index of refraction, proximate the mirror stack low-index layer 620. Here, the mirror stack high-index layer 625 is formed of zirconium oxide (ZrO₂). However, in some other implementations, the mirror stack high-index layer 625 may include other high-index materials, such as titanium oxide (TiO₂) and/or niobium pentoxide (Nb₂O₅), and may have a different thickness.

In some implementations, the mirror stack low-index layer 620 may have a relatively low chromatic dispersion as compared to the chromatic dispersion of the mirror stack high-index layer 625. The mirror stack high index layer 625 may reduce white-state null separation between short and long wavelengths. However, high refractive index materials generally have a higher dispersion that tends to increase the null separation. The combination of a layer of high index material (associated with high dispersion) and a layer of low dispersion material (associated with low index) may be optimum for decreasing the separation of nulls between the standing waves of different wavelengths. Therefore, the color of the white state produced by the MS-IMOD 500 may be improved.

The absorber stack 510 includes an absorber layer 635, which may be referred to herein as an “absorber stack absorber layer.” The absorber layer 635 is formed of vanadium (V) and has a thickness of approximately 7.2 nm in this example. In alternative implementations, the absorber layer 635 may include chromium (Cr), molybdenum (Mo), molychrome (MoCr), and/or another such material, and may be thicker or thinner than the absorber layer 635 of this example.

In this example, the absorber stack 510 includes an absorber stack low-index layer 640, having a relatively lower index of refraction. In this example, the absorber stack low-index layer 640 is proximate the absorber stack absorber layer 635. The absorber stack low-index layer 640 is disposed between the absorber stack absorber layer 635 and the substantially transparent substrate in this example. Here, the absorber stack 510 also includes an absorber stack high-index layer 645, having a relatively higher index of refraction, proximate the absorber stack low-index layer 640. The absorber stack high-index layer 645 is disposed between the absorber stack low-index layer 640 and the substantially transparent substrate 605 in this implementation.

In this example, the absorber stack low-index layer 640 and the absorber stack high-index layer 645 form an impedance-matching layer 660. As compared to implementations lacking an impedance-matching layer, the impedance-matching layer 660 may be capable of reducing reflection from the interface between the absorber layer 635 and the substantially transparent substrate 605. The impedance-matching layer 660 may be capable of providing substantially matching impedance throughout the entire visible wavelength, such that a dark black state may be achieved. In some implementations, the impedance-matching layer 660 may be optimized for color saturation of one or more colors, such as a red, green or blue color. For example, the thicknesses and/or indices of refraction of the absorber stack low-index layer 640 and the absorber stack high-index layer 645 may be capable of enhancing or diminishing the reflection of a particular wavelength range of visible light. In this example, the absorber stack low-index layer 640 is formed of SiO₂ and has a thickness of approximately 20 nm, and the absorber stack high-index layer 645 is formed of SiNₓ and has a thickness of approximately 17 nm. However, in some other implementations the absorber stack low-index layer 640 and/or the absorber stack high-index layer 645 may include other materials and may have different thicknesses.

In this implementation, the absorber stack 510 also includes passivation layer 630 as an etch stop. The passivation layer 630 is formed of Al₂O₃ and has a thickness of approximately 11 nm in this example, but may be formed of other suitable etch stop material, and may have other thicknesses.

As noted above, the attenuator 615 may be capable of reducing the amount of green light reflected when the MS-IMOD 500 is in a white state. Accordingly, the white color that is reflected when the MS-IMOD 500 is in the white state may be less greenish than that of implementations without the attenuator 615.

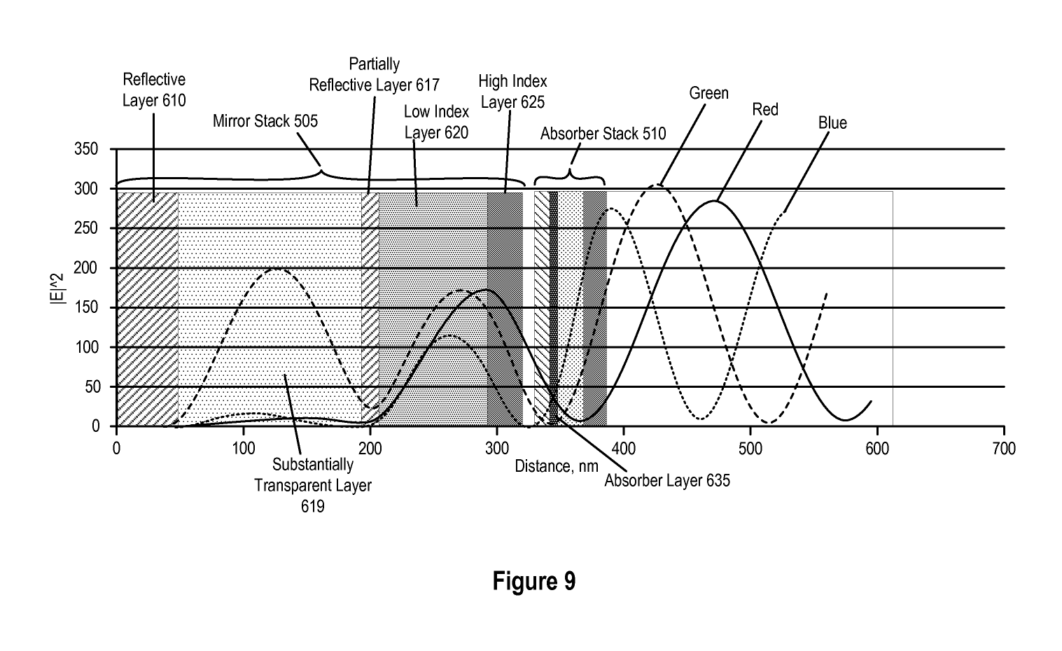

FIG. 9 shows example standing waves for red, green and blue superimposed on the stack shown in FIG. 6, when the MS-IMOD is positioned in a white state. As noted above, when the MS-IMOD 500 is positioned for a white state, the absorber layer 635 is located at the minimum field intensity of the light. However, because the minimum field intensities of the standing waves of red, blue and green wavelengths do not spatially overlap, the absorber may be positioned at the null for the intermediate-wavelength green field. Therefore, the reflected green color may be reinforced.

However, in this example the white-state color is not tinted with green due to the effect of the attenuator 615 in the mirror stack. In this example, the attenuator 615 includes a notch filter that is capable of reducing the amount of green light reflected when the MS-IMOD 500 is in a white state. It may be observed that the energy of the green standing wave is at a much higher level than that of the blue and red standing waves in the substantially transparent layer 619. However, the energy level of the green standing wave is reduced in the region between the partially reflective layer 617 and the absorber 635. Therefore, the white color that is reflected when the MS-IMOD 500 is in a white state may be less greenish than the white color of prior implementations.

In this implementation, the combined effect of the mirror stack low-index layer 620 and the mirror stack high-index layer 625 results in a reduced separation of the red, green and blue standing wave troughs at or near the absorber 635. Accordingly, the absorber 635 attenuates the red and blue standing waves relatively less than in implementations without the mirror stack low-index layer 620 and the mirror stack high-index layer 625.

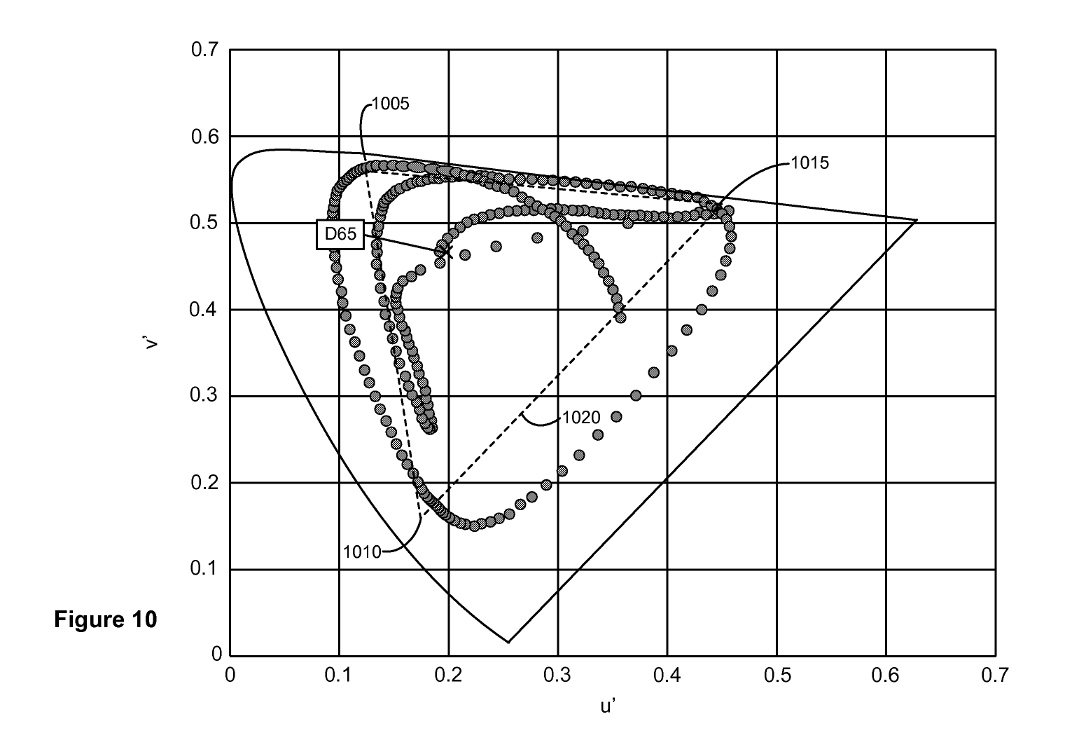

FIG. 10 shows an example of a color spiral generated by varying the air gap between the mirror stack and the absorber stack of the MS-IMOD 500 shown in FIG. 6 from substantially zero nm to approximately 600 nm. As shown in FIG. 10, the white state of this implementation produces a white color that is close to that of CIE Standard Illuminant D65. The red, green and blue colors provided by this MS-IMOD implementation closely approach the green corner 1005, the blue corner 1010 and the red corner 1015 of the sRGB color space 1020, indicating a high level of color saturation.

In some other MS-IMOD implementations, an improved white state may be achieved by including the attenuator 615 in the absorber stack 510. The attenuator 615 may be capable of reducing the amount of green light reflected when the MS-IMOD 500 is in a white state.

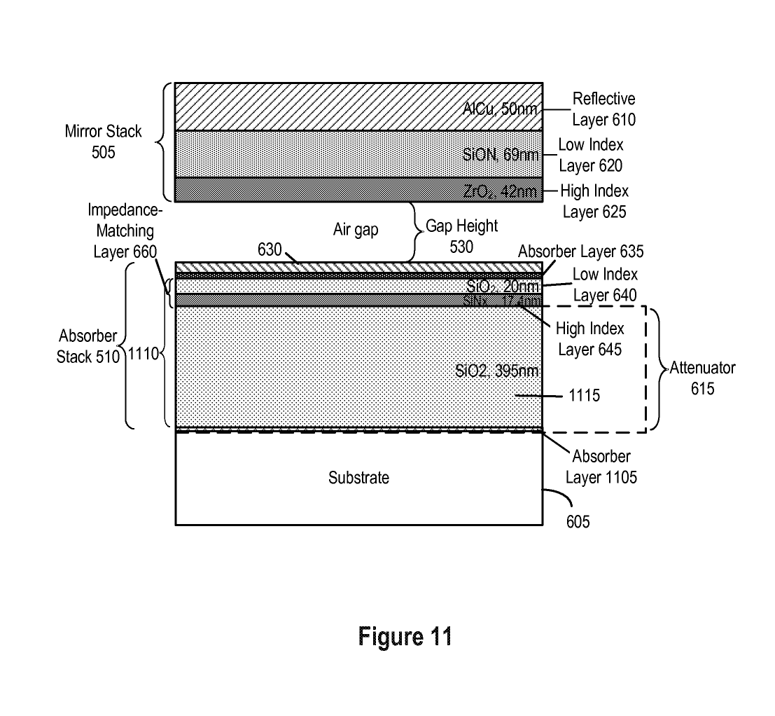

FIG. 11 shows an example of an MS-IMOD that includes an attenuator in the absorber stack. As with other implementations described herein, the configuration, thicknesses and materials shown and described by reference to FIG. 11 are merely provided by way of example. In this example, the absorber stack 510 includes a first absorber layer (the absorber layer 1105) proximate the substantially transparent substrate 605, a second absorber layer (the absorber layer 635) and a substantially transparent stack 1110 disposed between the first absorber layer and the second absorber layer. Here, the substantially transparent stack 1110 includes the impedance-matching layer 660 and a substantially transparent layer 1115, which is formed of SiO₂ in this example.

In this implementation, the absorber layer 635 and the absorber layer 1105 are both formed of vanadium (V). In this example, the absorber layer 635 is approximately 11 nm thick and the absorber layer 1005 is approximately 0.7 nm thick. However, in some other implementations, the absorber layer 635 and/or the absorber layer 1005 may include other materials, such as chromium (Cr), tungsten (W), nickel (Ni), titanium (Ti), rhodium (Rh), platinum (Pt), germanium (Ge), cobalt (Co) molybdenum (Mo), molychrome (MoCr, a molybdenum-chromium alloy) and/or another such material. Moreover, the absorber layer 635 and/or the absorber layer 1105 may be thicker or thinner than those of this implementation. For example, in some implementations the absorber layer 635 and the absorber layer 1105 may be in the range of 0.5 nm to 20 nm.

In alternative implementations, one or more of the elements shown in FIG. 11 may be disposed in a different position. For example, in some alternative implementations, the impedance-matching layer 660 may be disposed between the absorber layer 1105 and the substrate 605, which is a glass substrate in this example.

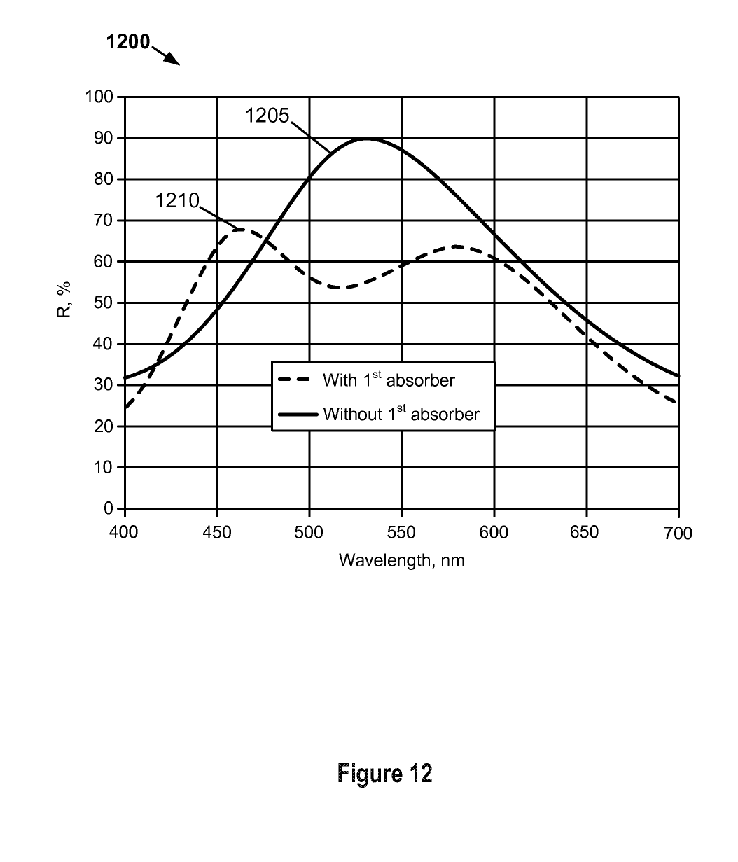

FIG. 12 shows an example graph that indicates the reflectivity of the MS-IMOD of FIG. 11 across the visible spectrum with and without the first absorber in the absorber stack. The curve 1205 indicates the reflectivity of an MS-IMOD that does not include the absorber layer 1005, whereas the curve 1210 indicates the reflectivity of an MS-IMOD that includes the absorber layer 1005. The curve 1205 indicates a strong peak in the green portion of the visible spectrum. The curve 1210 indicates that by including the absorber layer 1005 in the absorber stack 510, this peak is substantially attenuated. The curve 1210 also indicates a higher reflectivity in the blue portion of the visible spectrum.

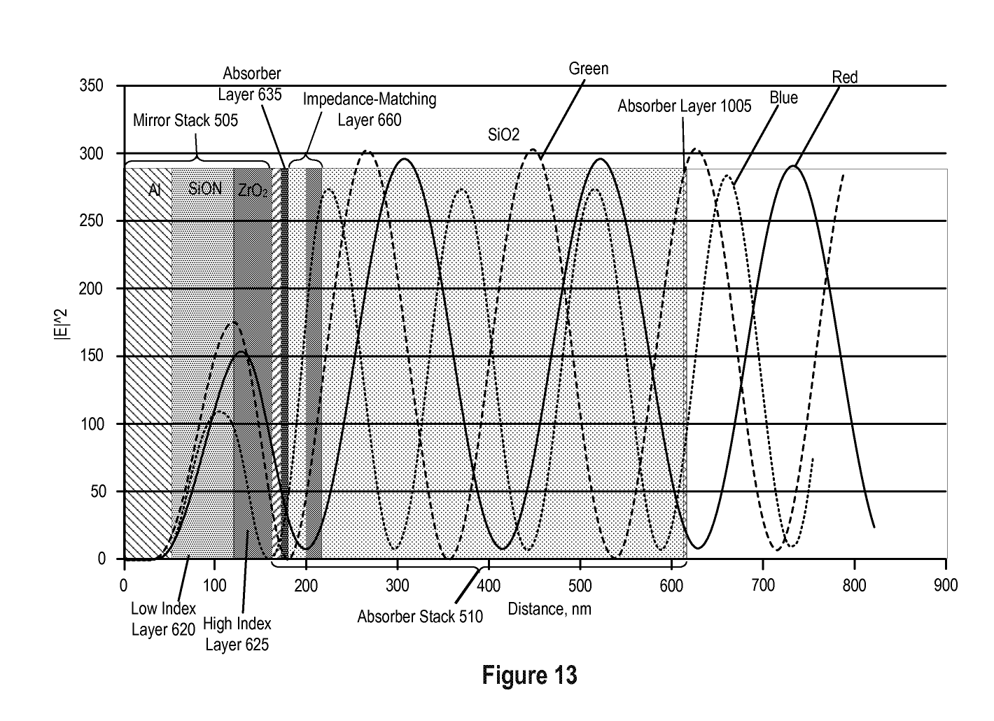

FIG. 13 shows example standing waves for red, green and blue superimposed on the stack shown in FIG. 11, when the MS-IMOD is positioned in a white state. In the example shown in FIG. 13, there is substantially no air gap when the MS-IMOD is positioned in a white state. Therefore, the mirror stack 505 is substantially adjacent to the absorber stack 510. The absorber layer 1005 is positioned at approximately 620 nm in this example, at which position the absorber layer 1005 is near a green standing wave peak and near blue and red standing wave troughs. Accordingly, the absorber layer 1005 attenuates green wavelengths of light substantially more than red or blue wavelengths. In alternative implementations, the absorber layer 1005 may be positioned in different locations at which a green standing wave peak is near blue and red standing wave troughs, such as approximately 440 nm.

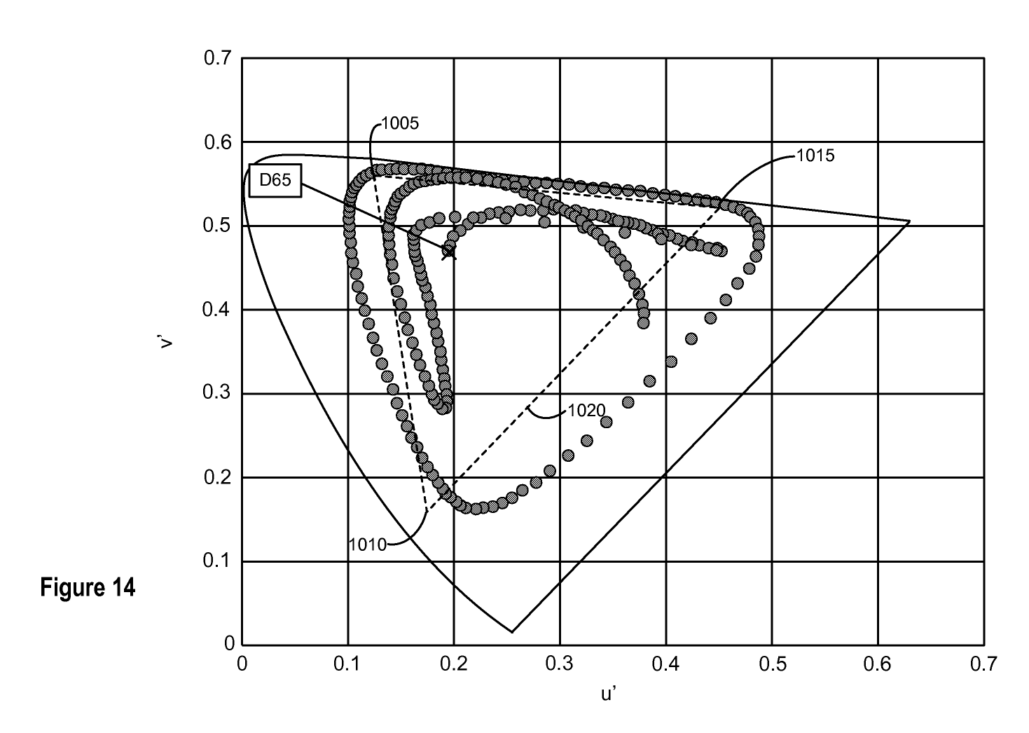

FIG. 14 shows an example of a color spiral generated by varying the air gap between the mirror stack and the absorber stack of the MS-IMOD shown in FIG. 11 from substantially zero nm to approximately 600 nm. As shown in FIG. 14, when it is illuminated by a CIE Standard Illuminant D65 light source, the white state of this implementation produces a white color that is very close to that of CIE Standard Illuminant D65. Moreover, some of the red and green colors provided by this MS-IMOD implementation are coincident with the green corner 1005 and the red corner 1015 of the sRGB color space 1020. The blue colors provided by this MS-IMOD implementation closely approach the blue corner 1010. Accordingly, this implementation provides excellent saturation for red and green colors and very good saturation for blue colors.

FIGS. 15A and 15B show system block diagrams illustrating an example display device that includes a plurality of IMOD display elements. In some implementations, the IMOD display elements may be MS-IMOD display elements as described elsewhere herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can include a flat-panel display, such as plasma, EL, OLED, STN LCD, or TFT LCD, or a non-flat-panel display, such as a CRT or other tube device. In addition, the display 30 can include an IMOD-based display. The display may include MS-IMODs such as those described herein.

The components of the display device 40 are schematically illustrated in FIG. 15A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 15A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. In some implementations, the processor 21 may correspond with, or form a component of, the control system 705 of FIG. 7. The driver controller 29 and/or the array driver also may be components of the control system 705. Accordingly, in some implementations, the processor 21, the driver controller 29 and/or the array driver may be capable of performing, at least in part, the methods described herein. For example, the processor 21, the driver controller 29 and/or the array driver may be part of a control system that is capable of controlling the absorber stacks 610 and the mirror stacks 605 of MS-IMODs 600 of the display 30 to be positioned in a plurality of positions relative to one another. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller, a bi-stable display controller or a multi-state display controller (such as an IMOD display element controller). Additionally, the array driver 22 can be a conventional driver, a bi-stable display driver or a multi-state display driver (such as an IMOD display element driver). Moreover, the display array 30 can be a conventional display array, a bi-stable display array or a multi-state display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of functioning as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An interferometric modulator (IMOD), comprising:
a mirror stack including a metal reflective layer;
a substantially transparent substrate; and
an absorber stack disposed on the substantially transparent substrate, the absorber stack including at least one absorber layer, wherein:
the absorber stack and the mirror stack are capable of being positioned in a plurality of positions relative to one another to form a plurality of gap heights;
each reflective color of a plurality of reflective colors of the IMOD corresponds with a gap height of the plurality of gap heights; and
at least one of the mirror stack or the absorber stack includes an attenuator capable of attenuating energy of light corresponding to one or more wavelength ranges.

2. The IMOD of claim 1, wherein the attenuator is capable of attenuating a wavelength range corresponding with green colors.

3. The IMOD of claim 1, wherein the absorber stack comprises:
the attenuator, which includes a first absorber layer proximate the substantially transparent substrate;
a second absorber layer; and
a substantially transparent stack disposed between the first absorber layer and the second absorber layer.

4. The IMOD of claim 3, wherein the absorber stack includes an impedance-matching layer.

5. The IMOD of claim 4, wherein the impedance-matching layer is disposed between the first absorber layer and the substantially transparent substrate or disposed proximate the second absorber layer.

6. The IMOD of claim 1, wherein the mirror stack includes the attenuator and wherein the attenuator includes a notch filter.

7. The IMOD of claim 6, wherein the notch filter includes a partially reflective partially absorptive layer and a substantially transparent layer disposed between the partially reflective layer and the reflective layer.

8. The IMOD of claim 6, wherein the mirror stack includes:
a mirror stack low-index layer, having a relatively lower index of refraction, proximate the notch filter; and
a mirror stack high-index layer, having a relatively higher index of refraction, proximate the mirror stack low-index layer.

9. A display device that includes the IMOD of claim 1.

10. The display device of claim 9, further including a control system capable of controlling the display device, wherein the control system is capable of processing image data.

11. The display device of claim 10, wherein the control system further comprises:
a driver circuit capable of sending at least one signal to a display of the display device; and
a controller capable of sending at least a portion of the image data to the driver circuit.

12. The display device of claim 10, wherein the control system further comprises:
an image source module capable of sending the image data to the processor, wherein the image source module includes at least one of a receiver, transceiver, and transmitter.

13. The display device of claim 10, further comprising:
an input device capable of receiving input data and of communicating the input data to the control system.

14. An interferometric modulator (IMOD), comprising:
a mirror stack including a reflective layer and a notch filter;
a substantially transparent substrate; and
an absorber stack disposed on the substantially transparent substrate, the absorber stack including at least one absorber layer, wherein the absorber stack and the mirror stack are capable of being positioned in a plurality of positions relative to one another to form a plurality of gap heights, and wherein each reflective color of a plurality of reflective colors of the IMOD corresponds with a gap height of the plurality of gap heights.

15. The IMOD of claim 14, wherein the notch filter includes a partially reflective layer and a substantially transparent layer disposed between the partially reflective layer and the reflective layer.

16. The IMOD of claim 14, wherein the notch filter is capable of attenuating a wavelength range corresponding with green colors.

17. The IMOD of claim 14, wherein the mirror stack includes:
a mirror stack low-index layer, having a relatively lower index of refraction, proximate the notch filter; and
a mirror stack high-index layer, having a relatively higher index of refraction, proximate the mirror stack low-index layer.

18. An interferometric modulator (IMOD), comprising:
a mirror stack including a reflective layer;
a substantially transparent substrate; and
an absorber stack disposed on the substantially transparent substrate and capable of attenuating energy of light corresponding to one or more wavelength ranges, the absorber stack including:
a first absorber layer proximate the substantially transparent substrate;
a second absorber layer; and
a substantially transparent stack disposed between the first absorber layer and the second absorber layer, wherein:
the absorber stack and the mirror stack are capable of being positioned in a plurality of positions relative to one another to form a plurality of gap heights; and
each reflective color of a plurality of reflective colors of the IMOD corresponds with a gap height of the plurality of gap heights.

19. The IMOD of claim 18, wherein the absorber stack includes an impedance-matching layer.

20. The IMOD of claim 19, wherein the impedance-matching layer is disposed between the first absorber layer and the substantially transparent substrate or disposed proximate the second absorber layer.
